(19) United States
(12) Patent Application Publication
(10) Pub. No.: US 2019/0144307 A1
(43) Pub. Date: May 16, 2019

(54) WATER PURIFIER

(71) Applicant: XIAMEN FILTERTECH INDUSTRIAL CORPORATION, Xiamen (CN)

(72) Inventors: MANG LU, Xiamen (CN); JIAN-YONG YAN, Xiamen (CN); BO-HUANG LIU, Xiamen (CN); HONG-KUN XU, Xiamen (CN)

(21) Appl. No.: 16/181,029

(22) Filed: Nov. 5, 2018

(30) Foreign Application Priority Data
Nov. 10, 2017 (CN) 201711104723.6

(51) Int. Cl. C02F 1/44; C02F 1/00; B01D 61/02

(52) U.S. Cl. CPC C02F 1/441; C02F 1/001; B01D 61/025; C02F 2209/40; C02F 2201/005; C02F 2209/10; C02F 2201/006

(57) ABSTRACT

Disclosed is a water purifier comprising: a water route integrated device, disposed in the water purifier; a pre-filter cartridge, disposed on a first card interface of a first auxiliary water route plate; a rear filter cartridge, disposed on a second card interface of the first auxiliary water route plate; a reverse osmosis (RO) film filter cartridge, disposed on a third card interface of a main water route plate; a standard piece module, disposed on the main water route plate, and is on a same side of the first auxiliary water route plate; and a pump module, disposed on the main water route plate, and is on a same side of the second auxiliary water route plate.

### BACKGROUND OF THE INVENTION

### Field of the Invention

The present invention relates to a water purifying device, and in particular to a water purifier having a water route integrated device.

### The Prior Arts

Nowadays, with the deteriorating problem of water pollution, safe and healthy drinking water is rather difficult to come by. To overcome this problem, a water purifying device is used in every household to clean and purify water effectively, to obtain safe and clean water for ordinary usage. Therefore, the various water purifying devices have very good prospects in the market. However, with the high price of housing, the space of living for every household is quite limited, so that the space left for accommodating water purifying device is very much limited. In other words, for a water purifying device, in addition to good water purifying capability required, the space it occupies must be kept as small as possible.

In this regard, as shown in FIG. 4, the water route plate 10 of a water purifying device can be a flat plate structure of one, two, or three layers. Therefore, in order to make the water route plate and the filter cartridge end portions to be on a same plane, the lengths of various filter cartridges must be the same. Yet, this could lead to insufficient use of the space for the filter cartridges, or their specifications can not meet the function requirement of a water purifying device, thus leading to the overly large size of the water purifier.

Therefore, presently, the design and performance of the water purifying device is not quite satisfactory, and it leaves much room for improvement.

### SUMMARY OF THE INVENTION

In order to solve the problems of the Prior Art, the present invention provides a water purifier, comprising: a water route integrated device, disposed in the water purifier; a pre-filter cartridge, disposed on a first card interface of a first auxiliary water route plate; a rear filter cartridge, disposed on a second card interface of the first auxiliary water route plate; a reverse osmosis (RO) film filter cartridge, disposed on a third card interface of a main water route plate; a standard piece module, disposed on the main water route plate, and is on a same side of the first auxiliary water route plate; and a pump module, disposed on the main water route plate, and is on a same side of the second auxiliary water route plate.

In an aspect of the present invention, a length of the pre-filter cartridge is the same as a length of the rear filter cartridge; and a length of the RO film filter cartridge is longer than the length of the pre-filter cartridge and the length of the rear filter cartridge.

In another aspect of the present invention, the water purifier further comprises: a water purifier outer shell, a water input interface, and a water output interface, and the water input interface and the water output interface are connected to the water purifier outer shell.

In yet another aspect of the present invention, the water route integrated device, the pre-filter cartridge, the rear filter cartridge, the reverse osmosis (RO) film filter cartridge, the standard piece module, and the pump module are all disposed in the water purifier outer shell.

In a further aspect of the present invention, the standard piece module and the main water route plate are formed into a water conduction route through a holed shaft.

In an aspect of the present invention, a pump module is connected to the main water route plate through a PE (Polyethylene) pipe.

In another aspect of the present invention, the water route integrated device includes: the main water route plate, on which is provided with the third card interface, the third card interface, the first card interface, and the second card interface are on a same side, the third card interface is used for installing the reverse osmosis (RO) film filter cartridge, so that tail ends of the pre-filter cartridge, the rear filter cartridge, and the RO film filter cartridge are on a same plane after installation; the first auxiliary water route plate, to be fixed on the main water route plate, on the first auxiliary water route plate is provided with the first card interface and the second card interface, the first card interface is used for installing the pre-filter cartridge, and the second card interface is used for installing the rear filter cartridge; and the second auxiliary water route plate, fixed under the main water route plate, used for installing water route components.

In yet another aspect of the present invention, the main water route plate, the first auxiliary water route plate, and the second auxiliary water route plate are formed into the water route integrated device through welding and fixing.

In a further aspect of the present invention, in the water route integrated device is provided with a water route flowing channel.

In an aspect of the present invention, on the main water route plate is provided with the water input interface and the water output interface.

In another aspect of the present invention, the water route components on the second auxiliary water route plate includes: a waste water electric magnetic valve, a flow meter, a check valve, and a pure water total dissolved solids (TDS) sensor.

In yet another aspect of the present invention, the water route integrated device is of a Z shape, and the main water route plate is of a Z shape.

In a further aspect of the present invention, the standard piece module is disposed at the left end of the main water route plate, and the RO film filter cartridge is disposed at the right end of the main water route plate.

In an aspect of the present invention, the water input interface and the water output interface are disposed at the right end of the main water route plate and the reverse osmosis (RO) film filter cartridge respectively, and are connected respectively to the water purifier outer shell, and in communication with outside of the water purifier.

In another aspect of the present invention, on the main water route plate is disposed the standard piece module, the pre-filter cartridge, the rear filter cartridge, the reverse osmosis (RO) film filter cartridge in sequence.

In yet another aspect of the present invention, the pump module is disposed at the left end of the main water route plate, and the second auxiliary water route plate is disposed at the right end of the main water route plate.

Compared with the Prior Art, the present invention has the following advantages: (1) For the inner space of the water purifier, the pre-filter cartridge and the rear filter cartridge of shorter lengths are disposed in cooperation with the reverse osmosis (RO) film filter cartridge of longer length, to utilize effectively the space in each of the filter cartridges to place the filtering material, to avoid waste of the filtering material. (2) The main water route plate is of a Z shape, to achieve compact structure of the water routes, so as to realize smaller size of the water purifier, to reduce the space occupied.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detail descriptions.

### BRIEF DESCRIPTION OF THE DRAWINGS

The related drawings in connection with the detailed descriptions of the present invention to be made later are described briefly as follows, in which:

FIG. 1 is an exploded view of a water purifier according to the present invention;

FIG. 2 is a schematic diagram of an assembled water purifier according to the present invention; and

FIG. 3 is a side view of a water purifier according to the present invention; and

FIG. 4 is a side view of a water purifying device according to the Prior Art.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the present invention, “one embodiment” or “an embodiment” refers to the specific characters, structures, or features in at least a way of implementing the present invention. It should be noted that, the terms “up”, “down”, “left”, “right” refer to the relative orientations or positions of the components in the drawing. Its purpose is to simplify the descriptions of the objects, and thus it should not be interpreted as limitations of the present invention. In addition, the terms “the first” ,“the second” should not be interpreted to mean the relative importance of the objects. Therefore, they are used to distinguish between/among different objects, and should not be interpreted to mean the order in sequence.

### Embodiment 1

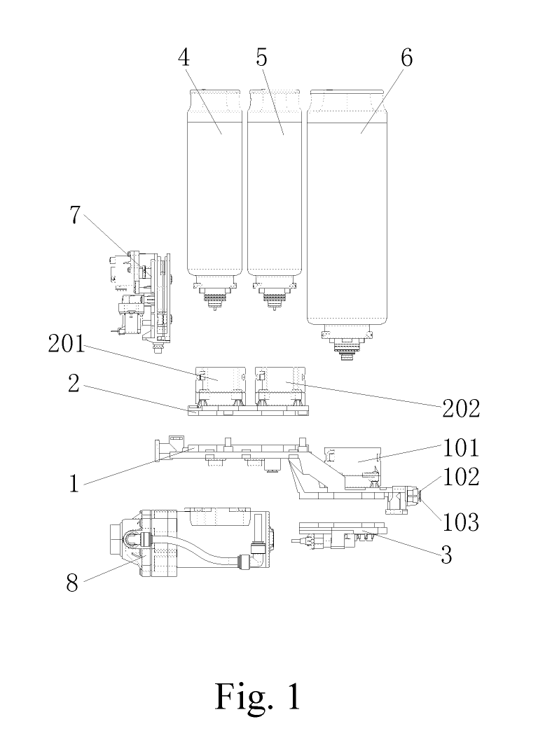

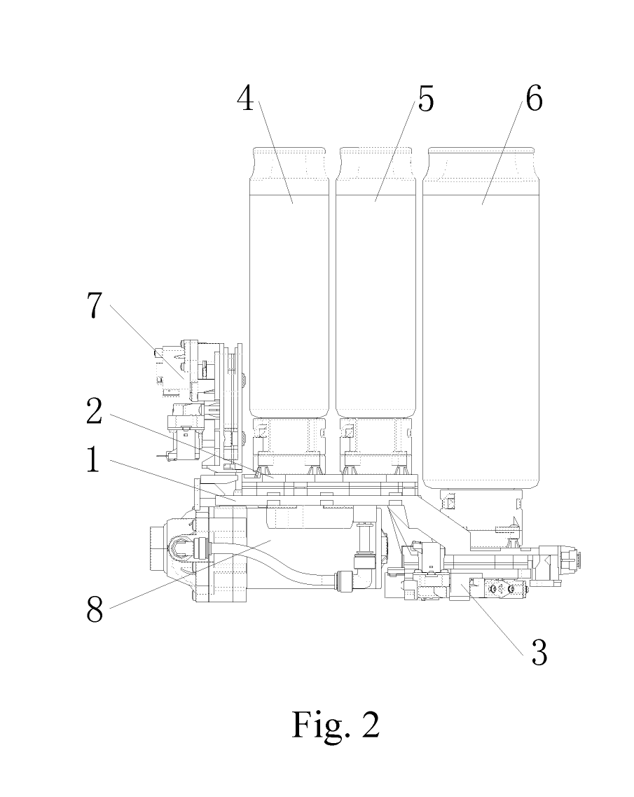

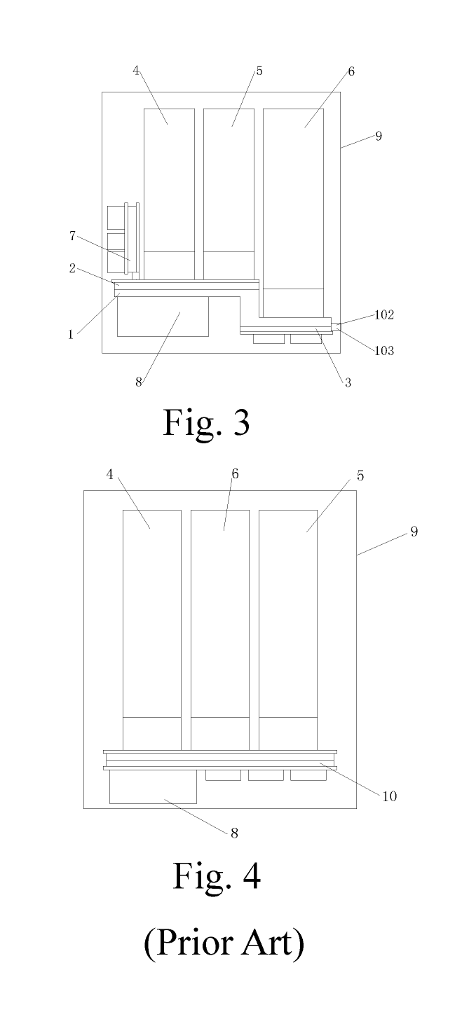

Refer to FIGS. 1 to 3 respectively for an exploded view of a water purifier according to the present invention; a schematic diagram of an assembled water purifier according to the present invention; and a side view of a water purifier according to the present invention.

As shown in FIGS. 1-3, the present invention provides a water purifier, comprising: a water route integrated device, disposed in the water purifier; a pre-filter cartridge 4, disposed on a first card interface 201 of a first auxiliary water route plate 2; a rear filter cartridge 5, disposed on a second card interface 202 of the first auxiliary water route plate 2; a reverse osmosis (RO) film filter cartridge 6, disposed on a third card interface 101 of a main water route plate 1; a standard piece module 7, disposed on the main water route plate 1, and is on a same side of the first auxiliary water route plate 2; and a pump module 8, disposed on the main water route plate 1, and is on a same side of the second auxiliary water route plate 3.

The length of the pre-filter cartridge 4 is the same as the length of the rear filter cartridge 5; and the length of the RO film filter cartridge 6 is longer than the length of the pre-filter cartridge 4 and the length of the rear filter cartridge 5.

The water purifier further comprises: a water purifier outer shell 9, a water input interface 102, and a water output interface 103. The water input interface 102 and the water output interface 103 are connected to the water purifier outer shell 9.

The water route integrated device, the pre-filter cartridge 4, the rear filter cartridge 5, the reverse osmosis (RO) film filter cartridge 6, the standard piece module 7, and the pump module 8 are all disposed in the water purifier outer shell 9.

The standard piece module 7 and the main water route plate 1 are formed into a water conduction route through a holed shaft.

The pump module 8 is connected to the main water route plate 1 through a PE (Polyethylene) pipe.

The water route integrated device includes: the main water route plate 1, on which is provided with the third card interface 101, the third card interface 101, the first card interface 201, and the second card interface 202 are on a same side, the third card interface 101 is used for installing the reverse osmosis (RO) film filter cartridge 6, so that tail ends of the pre-filter cartridge 4, the rear filter cartridge 5, and the RO film filter cartridge 6 are on a same plane after installation; the first auxiliary water route plate 2, to be fixed on the main water route plate 1, on the first auxiliary water route plate 2 is provided with the first card interface 201 and the second card interface 202, the first card interface 201 is used for installing the pre-filter cartridge 4, and the second card interface 202 is used for installing the rear filter cartridge 5; and the second auxiliary water route plate 3, fixed under the main water route plate 1, used for installing water route components.

The main water route plate 1, the first auxiliary water route plate 2, and the second auxiliary water route plate 3 are formed into the water route integrated device through welding and fixing.

In the water route integrated device is provided with a water route flowing channel.

On the main water route plate 1 is provided with the water input interface 102 and the water output interface 103.

The water route components on the second auxiliary water route plate 3 includes: a waste water electric magnetic valve, a flow meter, a check valve, and a pure water total dissolved solids (TDS) sensor.

The water route integrated device is of a Z shape, and the main water route plate 1 is of a Z shape.

The standard piece module 7 is disposed at the left end of the main water route plate 1, and the reverse osmosis (RO) film filter cartridge 6 is disposed at the right end of the main water route plate 1.

The water input interface 102 and the water output interface 103 are disposed at, right sides of the main water route plate 1 and the reverse osmosis (RO) film filter cartridge 6 respectively, and to be connected to the water purifier outer shell 9 and in communication with outside of the water purifier.

On the main water route plate 1 is disposed the standard piece module 7, the pre-filter cartridge 4, the rear filter cartridge 5, and the RO film filter cartridge 6 in sequence.

The pump module 8 is disposed at the left end of the main water route plate 1, and the second auxiliary water route plate 3 is disposed at the right end of the main water route plate 1.

### Embodiment 2

Refer to FIGS. 1 to 3 respectively for an exploded view of a water purifier according to the present invention; a schematic diagram of an assembled water purifier according to the present invention; and a side view of a water purifier according to the present invention.

As shown in FIGS. 1-3, the present invention provides a water purifier, comprising: a water route integrated device, disposed in the water purifier; a pre-filter cartridge 4, disposed on a first card interface 201 of a first auxiliary water route plate 2; a rear filter cartridge 5, disposed on a second card interface 202 of the first auxiliary water route plate 2; a reverse osmosis (RO) film filter cartridge 6, disposed on a third card interface 101 of a main water route plate 1; a standard piece module 7, disposed on the main water route plate 1, and is on a same side of the first auxiliary water route plate 2; and a pump module 8, disposed on the main water route plate 1, and is on a same side of the second auxiliary water route plate 3.

The length of the pre-filter cartridge 4 is the same as the length of the rear filter cartridge 5; and the length of the RO film filter cartridge 6 is longer than the length of the pre-filter cartridge 4 and the length of the rear filter cartridge 5.

The water purifier further comprises: a water purifier outer shell 9, a water input interface 102, and a water output interface 103. The water input interface 102 and the water output interface 103 are connected to the water purifier outer shell 9.

The water route integrated device, the pre-filter cartridge 4, the rear filter cartridge 5, the reverse osmosis (RO) film filter cartridge 6, the standard piece module 7, and the pump module 8 are all disposed in the water purifier outer shell 9.

The standard piece module 7 and the main water route plate 1 are formed into a water conduction route through a holed shaft.

The pump module 8 is connected to the main water route plate 1 through a PE (Polyethylene) pipe.

The water route integrated device includes: the main water route plate 1, under which is provided with the third card interface 101, the third card interface 101, the first card interface 201, and the second card interface 202 are on a same side, the third card interface 101 is used for installing the reverse osmosis (RO) film filter cartridge 6, so that tail ends of the pre-filter cartridge 4, the rear filter cartridge 5, and the RO film filter cartridge 6 are on a same plane after installation; the first auxiliary water route plate 2, to be fixed under the main water route plate 1, under the first auxiliary water route plate 2 is provided with the first card interface 201 and the second card interface 202, the first card interface 201 is used for installing the pre-filter cartridge 4, and the second card interface 202 is used for installing the rear filter cartridge 5; and the second auxiliary water route plate 3, fixed on the other side of the main water route plate 1, used for installing water route components.

The main water route plate 1, the first auxiliary water route plate 2, and the second auxiliary water route plate 3 are formed into the water route integrated device through welding and fixing.

In the water route integrated device is provided with a water route flowing channel.

On the main water route plate 1 is provided with the water input interface 102 and the water output interface 103.

The water route components on the second auxiliary water route plate 3 includes: a waste water electric magnetic valve, a flow meter, a check valve, and a pure water total dissolved solids (TDS) sensor.

The water route integrated device is of a Z shape, and the main water route plate 1 is of a Z shape.

The standard piece module 7 is disposed at the left end of the main water route plate 1, and the reverse osmosis (RO) film filter cartridge 6 is disposed at the right end of the main water route plate 1.

The water input interface 102 and the water output interface 103 are disposed at the right sides of the main water route plate 1 and the reverse osmosis (RO) film filter cartridge 6, and to be connected to the water purifier outer shell 9 and in communication with outside of the water purifier.

Under the main water route plate 1 is disposed the standard piece module 7, the pre-filter cartridge 4, the rear filter cartridge 5, and the RO film filter cartridge 6 in sequence.

The pump module 8 is disposed at the left end of the main water route plate 1, and the second auxiliary water route plate 3 is disposed at the right end of the main water route plate 1.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A water purifier, comprising:
a water route integrated device, disposed in the water purifier;
a pre-filter cartridge, disposed on a first card interface of a first auxiliary water route plate;
a rear filter cartridge, disposed on a second card interface of the first auxiliary water route plate;
a reverse osmosis (RO) film filter cartridge, disposed on a third card interface of a main water route plate;
a standard piece module, disposed on the main water route plate, and is on a same side of the first auxiliary water route plate; and
a pump module, disposed on the main water route plate, and is on a same side of the second auxiliary water route plate.

2. The water purifier as claimed in claim 1, wherein a length of the pre-filter cartridge is the same as a length of the rear filter cartridge, and a length of the RO film filter cartridge is longer than the length of the pre-filter cartridge and the length of the rear filter cartridge.

3. The water purifier as claimed in claim 1, further comprising:
a water purifier outer shell, a water input interface, and a water output interface, and the water input interface and the water output interface are connected to the water purifier outer shell.

4. The water purifier as claimed in claim 3, wherein the water route integrated device, the pre-filter cartridge, the rear filter cartridge, the reverse osmosis (RO) film filter cartridge, the standard piece module, and the pump module are all disposed in the water purifier outer shell.

5. The water purifier as claimed in claim 1, wherein the standard piece module and the main water route plate are formed into a water conduction route through a holed shaft.

6. The water purifier as claimed in claim 1, wherein a pump module is connected to the main water route plate through a PE (Polyethylene) pipe.

7. The water purifier as claimed in claim 1, wherein
the water route integrated device includes:
the main water route plate, on which is provided with the third card interface, the third card interface, the first card interface, and the second card interface are on a same side, the third card interface is used for installing the reverse osmosis (RO) film filter cartridge, so that tail ends of the pre-filter cartridge, the rear filter cartridge, and the RO film filter cartridge are on a same plane after installation;
the first auxiliary water route plate, to be fixed on the main water route plate, on the first auxiliary water route plate is provided with the first card interface and the second card interface, the first card interface is used for installing the pre-filter cartridge, and the second card interface is used for installing the rear filter cartridge; and
the second auxiliary water route plate, fixed under the main water route plate, used for installing water route components.

8. The water purifier as claimed in claim 7, wherein the main water route plate, the first auxiliary water route plate, and the second auxiliary water route plate are formed into the water route integrated device through welding and fixing.

9. The water purifier as claimed in claim 7, wherein in the water route integrated device is provided with a water route flowing channel.

10. The water purifier as claimed in claim 7, wherein on the main water route plate is provided with the water input interface and the water output interface.

11. The water purifier as claimed in claim 7, wherein the water route components on the second auxiliary water route plate includes: a waste water electric magnetic valve, a flow meter, a check valve, and a pure water total dissolved solids (TDS) sensor.

12. The water purifier as claimed in claim 7, wherein the water route integrated device is of a Z shape, and the main water route plate is of a Z shape.
